(19) United States
(12) Patent Application Publication
(10) Pub. No.: US 2026/0074823 A1
(43) Pub. Date: Mar. 12, 2026

(54) SYSTEMS, APPARATUSES, METHODS, AND NON-TRANSITORY COMPUTER-READABLE STORAGE DEVICES FOR LINK ADAPTATION IN WIRELESS LOCAL AREA NETWORK

(71) Applicant: HUAWEI TECHNOLOGIES CO., LTD., Shenzhen (CN)

(72) Inventors: SARA NOROUZI, Vancouver (CA); Osama Aboul-Magd, Kanata (CA); Jung Hoon Suh, Kanata (CA); Mahmoud Hasabelnaby, Kelowna (CA); Yan Xin, Kanata (CA)

(21) Appl. No.: 18/830,809

(22) Filed: Sep. 11, 2024

(51) Int. Cl. H04L 1/00; H04L 1/20; H04W 84/12

(52) U.S. Cl. CPC H04L 1/0034; H04L 1/0003; H04L 1/0009; H04L 1/20; H04W 84/12

(57) ABSTRACT

A fast link adaptation method using block acknowledgement frames is described. The method can comprise an exchange of an add block acknowledgement (ADDBA) request frame and an ADDBA response frame between a first and a second communication device, wherein each of the ADDBA request and response frames comprises a link adaptation negotiation field for negotiation of at least one link adaptation parameter of the communication link. The method can alternatively or additionally comprise an exchange of a block acknowledgement request (BAR) frame and a block acknowledgement (BA) frame between the first and the second communication device, wherein the BAR frame comprises a link adaptation information request for feedback of at least one link adaptation parameter of the communication link; and the BA frame comprises a link adaptation information response relating to the at least one link adaptation parameter of the communication link.

### FIELD OF THE DISCLOSURE

The present disclosure relates generally to communication systems, apparatuses, methods, and non-transitory computer-readable storage devices, and in particular to systems, apparatuses, methods, and non-transitory computer-readable storage devices for link adaptation (LA) in a wireless local-area network (WLAN).

### BACKGROUND

IEEE 802.11 working group is exploring a next generation WI-FI® technology beyond IEEE 802.11be (WI-FI® 7; WI-FI is a registered trademark of Wi-Fi Alliance, Austin, TX, USA), which may target at a maximum throughput of at least 100 Gbps. The next generation WI-FI® technology aims to support ultra-high reliability (UHR) communications which require more robust transmission schemes to guarantee high reliability of delivery of the associated traffic. In addition to high reliability transmissions, UHR communications may also require more efficient use of the spectrum and/or an improved latency to address the urgent need of the traffic.

Link adaptation (LA) plays an important role for WI-FI® systems, in enabling improvements in these goals for the next generation WI-FI® systems. However, existing solutions suffer from various limitations in practice relating to, for example, trust issue, adaptation speed, throughput, and/or efficiency.

There remains a need to develop an LA scheme for the next generation WI-FI® technology that addresses at least some of the deficiencies of the existing solutions.

### SUMMARY

According to one aspect of this disclosure, there is provided a first communication method comprising: a first communication device sending an add block acknowledgement (ADDBA) request frame to a second communication device through a communication link; and the first communication device receiving an ADDBA response frame from the second communication device through the communication link, wherein each of the ADDBA request frame and the ADDBA response frame comprises a link adaptation negotiation field for negotiation of at least one link adaptation parameter of the communication link.

In some embodiments, the link adaptation negotiation field comprises a criterion based on the at least one link adaptation measurement and a corresponding level of the at least one link adaptation measurement.

In some embodiments, the at least one link adaptation measurement comprises one or more of a throughput, a signal-to-noise ratio (SNR), or a packet error rate (PER) of the communication link.

In some embodiments, the link adaptation negotiation field is a new field added to the corresponding ADDBA request or response frame; or is included in an existing field of the corresponding ADDBA request or response frame.

According to one aspect of this disclosure, there is provided a second communication method comprising: a first communication device sending a block acknowledgement request (BAR) frame to a second communication device through a communication link, wherein the BAR frame comprises a link adaptation information request for feedback of at least one link adaptation parameter of the communication link; and the first communication device receiving a block acknowledgement (BA) frame from the second communication device through the communication link, wherein the BA frame comprises a link adaptation information response relating to the at least one link adaptation parameter of the communication link.

In some embodiments, the BAR frame comprises a first link adaptation information field specifying the link adaptation information request, the first link adaptation information field being positioned after a BAR control field or a BAR information field in the BAR frame; and the BA frame comprises a second link adaptation information field specifying the link adaptation information response, the second link adaptation information field being positioned after a BA control field or a BA information field in the BA frame.

In some embodiments, the BAR control field comprises one bit indicating an existence of the first link adaptation information field in the BAR frame; and the BA control field comprises one bit indicating an existence of the second link adaptation information field in the BA frame.

In some embodiments, the link adaptation information response comprises a recommendation or measurement relating to the at least one link adaptation parameter.

In some embodiments, the BAR frame comprises a BAR type subfield including one value indicating an existence of the link adaptation information request in the BAR frame and the BA frame comprises a BA type subfield including one value indicating an existence of the link adaptation information response in the BA frame.

In some embodiments, the BAR frame comprises a BAR information field specifying the link adaptation information request; and the BA frame comprises a BA information field specifying the link adaptation information response.

In some embodiments, the link adaptation information request for feedback of the at least one link adaptation parameter comprises a request for feedback of a single link adaptation parameter of the communication link.

In some embodiments, the BAR frame comprises a BAR control field including two bits for specifying the link adaptation information request for feedback of the single link adaptation parameter.

In some embodiments, the BA frame comprises a BA control field including four bits for specifying the link adaptation information response of the single link adaptation parameter.

In some embodiments, the single link adaptation parameter is one of a modulation and coding scheme (MCS), a number of spatial streams (NSS) and an unequal modulation (UEQM) pattern of the communication link.

According to one aspect of this disclosure, there is provided a third communication method comprising a first communication device receiving a BA frame from a second communication device through a communication link, wherein the BA frame comprises a recommendation for increasing an MCS level of the communication link between the first communication device and the second communication device.

In some embodiments, the BA frame comprises a BA control field, and the BA control field comprises two bits for specifying the recommendation for increasing the MCS level of the communication link between the first communication device and the second communication device.

In some embodiments, the recommendation for increasing the MCS level comprises a two-bit value k indicating the recommendation for increasing the MCS level by m×k levels, where m is an integer larger or equal to 1.

According to one aspect of this disclosure, there is provided a first communication device or apparatus comprising: one or more processors functionally connected to one or more non-transitory machine-readable memories storing thereon machine-executable instructions, and the one or more processors are configured to execute the machine-executable instructions and cause the communication apparatus to perform the above-described methods.

According to one aspect of this disclosure, there is provided a fourth communication method comprising: a second communication device receiving an ADDBA request frame from a first communication device through a communication link; and the second communication device sending an ADDBA response frame to the first communication device through the communication link, wherein each of the ADDBA request frame and the ADDBA response frame comprises a link adaptation negotiation field for negotiation of at least one link adaptation parameter of the communication link.

In some embodiments, the link adaptation negotiation field comprises a criterion based on the at least one link adaptation measurement and a corresponding level of the at least one link adaptation measurement.

In some embodiments, the at least one link adaptation measurement comprises one or more of a throughput, a SNR, or a PER of the communication link.

In some embodiments, the link adaptation negotiation field is a new field added to the corresponding ADDBA request or response frame; or is included in an existing field of the corresponding ADDBA request or response frame.

According to one aspect of this disclosure, there is provided a fifth communication method comprising: a second communication device receiving a BAR frame from a first communication device through a communication link, wherein the BAR frame comprises a link adaptation information request for feedback of at least one link adaptation parameter of the communication link; and the second communication device sending a BA frame to the first communication device through the communication link, wherein the BA frame comprises a link adaptation information response relating to the at least one link adaptation parameter of the communication link.

In some embodiments, the BAR frame comprises a first link adaptation information field specifying the link adaptation information request, the first link adaptation information field being positioned after a BAR control field or a BAR information field in the BAR frame; and the BA frame comprises a second link adaptation information field specifying the link adaptation information response, the second link adaptation information field being positioned after a BA control field or a BA information field in the BA frame.

In some embodiments, the BAR control field comprises one bit indicating an existence of the first link adaptation information field in the BAR frame; and the BA control field comprises one bit indicating an existence of the second link adaptation information field in the BA frame.

In some embodiments, the link adaptation information response comprises a recommendation or measurement relating to the at least one link adaptation parameter.

In some embodiments, the BAR frame comprises a BAR type subfield including one value indicating an existence of the link adaptation information request in the BAR frame and the BA frame comprises a BA type subfield including one value indicating an existence of the link adaptation information response in the BA frame.

In some embodiments, the BAR frame comprises a BAR information field specifying the link adaptation information request; and the BA frame comprises a BA information field specifying the link adaptation information response.

In some embodiments, the link adaptation information request for feedback of the at least one link adaptation parameter comprises a request for feedback of a single link adaptation parameter of the communication link.

In some embodiments, the BAR frame comprises a BAR control field including two bits for specifying the link adaptation information request for feedback of the single link adaptation parameter.

In some embodiments, the BA frame comprises a BA control field including four bits for specifying the link adaptation information response of the single link adaptation parameter.

In some embodiments, the single link adaptation parameter is one of an MCS, an NSS and a UEQM pattern of the communication link.

According to one aspect of this disclosure, there is provided a sixth communication method comprising a second communication device sending a BA frame to a first communication device through a communication link, wherein the BA frame comprises a recommendation for increasing an MCS level of the communication link between the first communication device and the second communication device.

In some embodiments, the BA frame comprises a BA control field, and the BA control field comprises two bits for specifying the recommendation for increasing the MCS level of the communication link between the first communication device and the second communication device.

In some embodiments, the recommendation for increasing the MCS level comprises a two-bit value k indicating the recommendation for increasing the MCS level by m×k levels, where m is an integer larger or equal to 1.

According to one aspect of this disclosure, there is provided a second communication device or apparatus comprising: one or more processors functionally connected to one or more non-transitory machine-readable memories storing thereon machine-executable instructions, and the one or more processors are configured to execute the machine-executable instructions and cause the communication apparatus to perform the above-described methods.

According to one aspect of this disclosure, there is provided one or more circuits such as one or more processors for performing the above-described methods.

According to one aspect of this disclosure, there is provided one or more processors functionally connected to one or more memories for performing the above-described methods.

According to one aspect of this disclosure, there is provided one or more non-transitory computer-readable storage devices comprising computer-executable instructions, wherein the instructions, when executed, cause one or more circuits to perform the above-described methods.

According to one aspect of this disclosure, there is provided an apparatus, and configured to perform the any one of above-mentioned methods and their embodiments. Specifically, the apparatus includes one or more units configured to perform the any one of above-mentioned methods and their embodiments.

According to one aspect of this disclosure, there is provided a non-transitory computer-readable storage medium. The non-transitory computer-readable storage medium stores a computer program, and when the computer program is executed by an apparatus, the apparatus is enabled to implement the any one of above-mentioned methods and their embodiments.

According to one aspect of this disclosure, there is provided a computer program product including one or more instructions. When the instructions are executed by an apparatus such as a computer, the apparatus is enabled to implement the any one of above-mentioned methods and their embodiments.

According to one aspect of this disclosure, there is provided a communication system. The communication system includes a first communication device and/or a second communication device, the first communication device and the second communication device are configured to perform the above-described communication methods.

According to one aspect of this disclosure, there is provided an apparatus for implementing the methods in any possible implementation of the foregoing aspects.

The systems, apparatuses, methods, and non-transitory computer-readable storage devices disclosed herein therefore provide various link adaptation (LA) communication methods between a transmitter and a receiver.

By introducing an LA negotiation field in the ADDBA frame (either as a new field or included in an existing field), the transmitter and the receiver can exchange and negotiate LA information for one or more LA parameters associated with the communication link.

The LA information can therefore be negotiated/established during the initialization of a block acknowledgement (Block ACK) session, allowing efficient exchange of LA information without relying on individual acknowledgements, thereby improving network throughput and adaptation speed compared to existing ACK-based approaches.

The LA communication methods disclosed herein can also utilize block acknowledgement request (“BAR”, or “BlockAckReq”) frames and block acknowledgement (“BA”, or “BlockAck”) frames for exchanging LA information, either by way of introducing new fields in the BAR and BA frames, or by using existing bits in the BAR and BA frames.

Both the use of ADDBA frames and the use of BAR/BA frames to exchange LA information can enable the transmitter to obtain LA information that is negotiated and/or agreed upon between the transmitter and the receiver. Compared to the high throughput control (HTC)-based approaches, the LA communication methods disclosed herein can establish more trust at the transmitter which is accountable for the successful transfer of data to the receiver. The transmitter can also obtain LA information beyond the Block ACK and the signal strength indicator (RSSI) to evaluate the channel conditions and can in turn provide more effective LA measures adjusting to the channel conditions.

The LA communication methods disclosed herein may be related to the standardization of next generation of IEEE 802.11be supporting ultra-high reliability (UHR) communications (for example, IEEE 802.11bn or WI-FI® 8 systems) and the like.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIG. 4 is a schematic diagram showing the general structure of a media access control (MAC) frame in IEEE 802.11;

FIG. 5 is a schematic diagram showing the structure of a control information subfield in a high-level architecture/enhanced link adaptation (HLA/ELA) control field;

FIG. 6 is a schematic diagram showing the structure of a block acknowledgement request (BAR) frame carrying link adaptation (LA) information, in accordance with some embodiments of this disclosure;

FIG. 7 is a schematic diagram showing the structure of a block acknowledgement (BA) frame carrying LA information, in accordance with some embodiments of this disclosure;

FIG. 8 is a schematic diagram showing the structure of a BA frame carrying LA information, in accordance with some embodiments of this disclosure;

FIG. 9 is a schematic diagram showing the structure of a BAR frame carrying LA information, in accordance with some embodiments of this disclosure;

FIG. 10 is a schematic diagram showing the structure of a BA frame carrying LA information, in accordance with some embodiments of this disclosure;

FIG. 11 is a schematic diagram showing the structure of a BAR frame with LA information, in accordance with some embodiments of this disclosure;

FIG. 12 is a schematic diagram showing the structure of a BA frame with LA information, in accordance with some embodiments of this disclosure;

FIG. 13 is a schematic diagram of an LA communication method, in accordance with some embodiments of the disclosure;

FIG. 14 is a flow chart of a first communication method, in accordance with some embodiments of the disclosure;

FIG. 15 is a flow chart of a second communication method, in accordance with some embodiments of the disclosure;

FIG. 16 is a flow chart of a third communication method, in accordance with some embodiments of the disclosure.

### DETAILED DESCRIPTION

Embodiments disclosed herein relate to wireless communication systems, apparatuses, methods, and non-transitory computer-readable storage devices for link adaptation (LA) in a wireless local-area network (WLAN). The wireless communication systems, apparatuses, methods and non-transitory computer-readable storage devices disclosed herein are suitable for fast LA using block acknowledgement (ACK) frames. The wireless communication systems, apparatuses, and methods disclosed herein may be any suitable systems, apparatuses, and methods for transmitting wireless signals. Examples of such systems may be WLAN ultra-high reliability (UHR) systems (for example, IEEE 802.11bn or WI-FI® 8 systems), 5G or 6G wireless mobile communication systems, and the like.

### A. System Structure

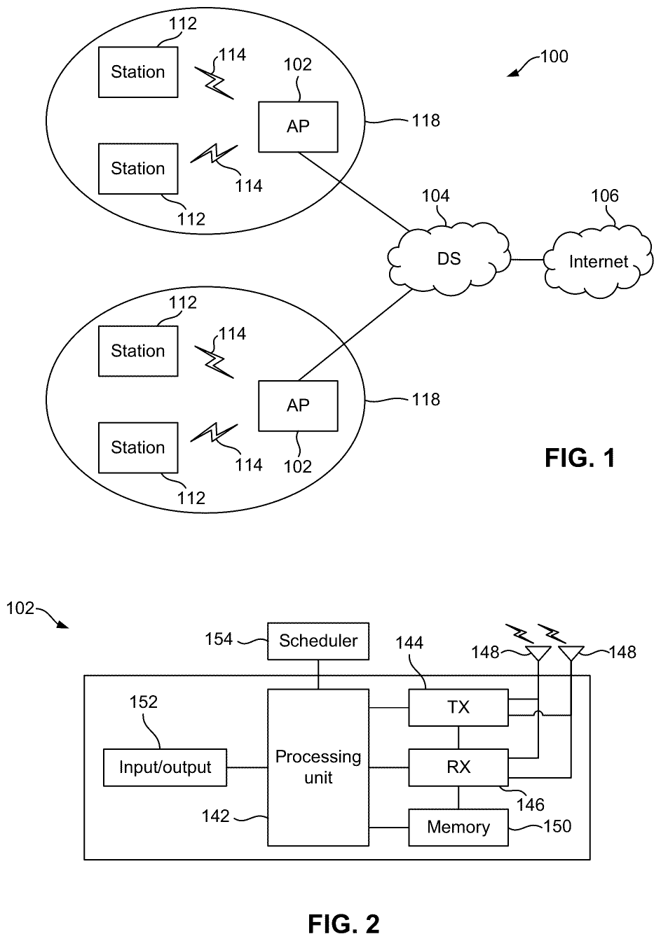

Turning now to FIG. 1, a communication system according to some embodiments of this disclosure is shown and is generally identified using reference numeral 100. As an example, the communication system 100 may be a WI-FI® system built under relevant standards such as IEEE 802.11 standard. As shown, the communication system 100 comprises a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (STAs) through respective wireless channels 114 (or “wireless links”, or simply “links”) for providing wireless network connected thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 comprises at least one processing unit 142 (also denoted at least one “processor”), at least one transmitter (TX; also used as the abbreviation of “transmission”) 144, at least one receiver (RX; also used as the abbreviation of “receiving”) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

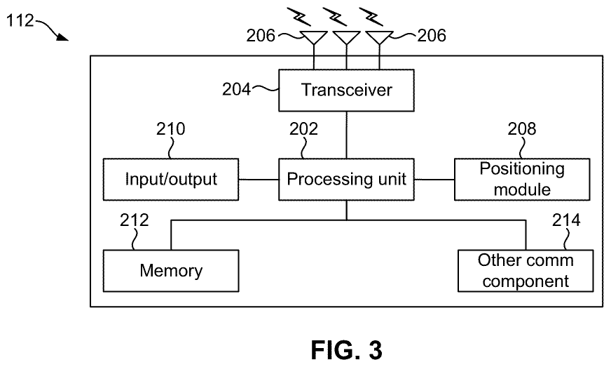

FIG. 3 is a simplified schematic diagram of a STA 112. As shown, the STA 112 comprises at least one processing unit 202, at least one transceiver 204, at least one antenna or network interface controller (NIC) 206, at least one positioning module 208, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning devices such as navigation satellites for determining the location of the STA 112. The navigation satellites may be satellites of a global navigation satellite system (GNSS) such as the Global Positioning System (GPS) of USA, Globa “naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning device for determining the location of the STA 112.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In physical layer, the frequency-time resource of the channel 114 is partitioned into physical layer protocol data units (PPDUs; also called “packets”), and the AP 102 or STA 112 transmits data as PPDUs or packets. Suitable modulation technologies may be used for communication between the AP 102 and the STA 112. For example, in some embodiments, orthogonal frequency-division multiplexing (OFDM) may be used wherein the channel 114 is partitioned into a plurality orthogonal subchannels for communication between the AP 102 and the STA 112. Moreover, as there is usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

For purposes of this disclosure, a communication link can be any type of wireless communication channel between two suitable communication devices, including an AP 102 and a STA 112. A transmitting device or a transmitter of a communication link may be an AP 102 or a STA 112, and a receiving device or a receiver of the communication link may also be an AP 102 or a STA 112. For example, the transmitting device may be an AP 102, while the receiving device may be a STA 112. Alternatively, the transmitting device may be a STA 112, and the receiving device may be an AP 102. In some embodiments, the transmitting and receiving device can be both APs 102 or both STAs 112.

In some embodiments, the communication system 100 may operate in a multi-link transmission mode, where one AP 102 may establish a plurality of links with a plurality of devices (such as one or more STA 112). Similarly, a non-AP device such as a STA 112 may establish a plurality of links with a plurality of devices (such as one or more AP 102).

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel.

### B. Link Adaptation

Link adaptation (LA) refers to the process of dynamically adjusting transmission parameters to match the current conditions of the wireless channel in WI-FI® networks.

LA is an important process for optimizing performance in varying link conditions, enabling improvements in reliability, spectral efficiency, and/or latency, all of which are important goals of IEEE 802.11bn or ultra-high reliability (UHR) technology. Because physical channels and transmission schemes are not necessarily symmetric, LA can also play an important role for both DL and UL transmissions.

Two mechanisms are currently employed for LA, referred to as a high throughput control (HTC)-based LA approach and an acknowledgement (ACK)-based LA approach respectively. However, these mechanisms suffer from various limitations in practice. ACK-based approaches suffer from slow adaptation and loss of throughput and efficiency. Trust between the transmitter and the receiver can be a main issue with the HTC-based approaches.

More specifically, an HTC-based LA approach uses a high throughput (HT) control field in high efficiency/extremely high throughput (HE/EHT) variants for carrying the LA parameters.

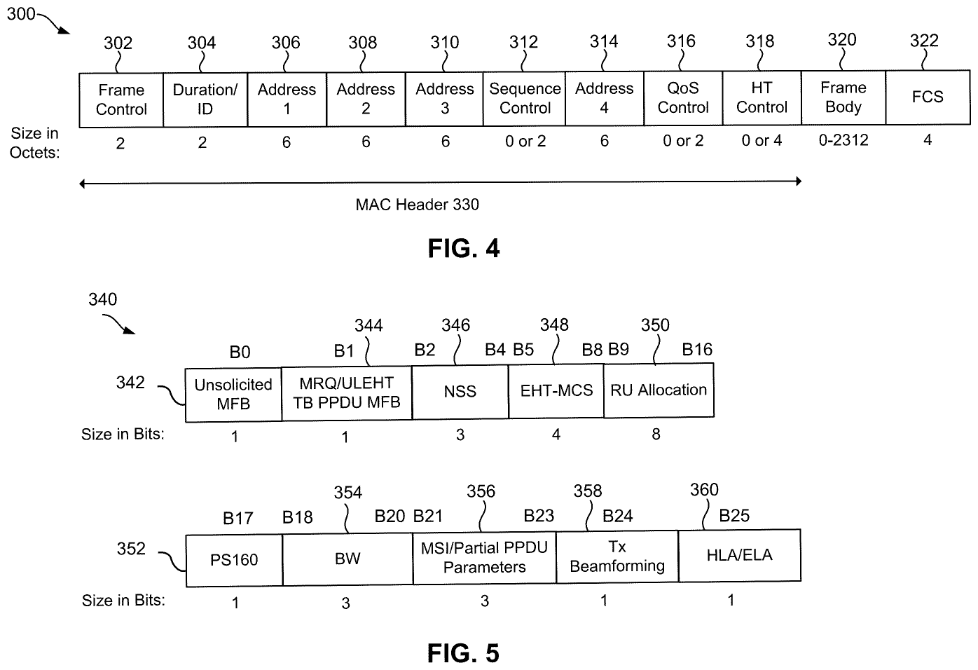

FIG. 4 provides a schematic diagram of the general structure of a media access control (MAC) frame 300 in IEEE 802.11. As shown in FIG. 4, the MAC frame 300 in a PPDU comprises a MAC header 330 consisting of nine (9) fields. The nine (9) fields are a two-byte frame control field 302, a two-byte duration/ID field 304, a six-byte address one (1) field 306, a six-byte address two (2) field 308, a six-byte address three (3) field 310, a zero or two-byte sequence control field 312, a six-byte address four (4) field 314, a zero or two-byte quality-of-service (QoS) control field 316, and a zero or four-byte HT control field 318. The MAC frame 300 also comprises a frame body 320 of a variable size (i.e., zero (0) to two-thousand-three-hundred-and-twelve (2312) bytes) and a four-byte frame check sequence (FCS) field 322.

The HT control field 318 is present in a control wrapper frame, QoS data frame, and management frames as determined by a +HTC subfield of the frame control field 302. The format of the HT control field 318 transmitted by a non-millimeter-wave multiple gigabit (CMMG) STA can be defined as follows:

TABLE 1
HT control variants

| Variant | B0 | B1 | B2-B29 | B30 | B31 |
|---|---|---|---|---|---|
| HT | 0 | HT Control Middle | | Access Category | Reverse Direction |
| | | | | (AC) Constraint | Grant (RDG)/ |
| | | | | | More PPDU |
| Very High | 1 | 0 | VHT Control | AC Constraint | RDG/More |
| Throughput (VHT) | | | Middle | | PPDU |
| High | 1 | 1 | A-Control | | |
| Efficiency/Extremely | | | | | |
| High Throughput | | | | | |
| (HE/EHT) | | | | | |

In the HTC-based LA approach, the HT control field 318 in the HE/EHT variant carries the LA parameters. The A-control subfield is 30 bits in length including 4 bits for control ID and variable length for control information. More specifically, control ID “0010” indicates the high-level architecture/enhanced link adaptation (HLA/ELA) control field and twenty-six (26) bits are allocated for control information.

FIG. 5 is a schematic diagram showing the structure of the twenty-six bits control information subfield 340 in the HLA/ELA control field. As shown in FIG. 5, the control information subfield 340 comprises a one-bit unsolicited modulation feedback (MFB) subfield 342, a one-bit modulation and coding scheme (MCS) request/ultra extremely high throughput (MRQ/ULEHT) trigger-based (TB) PPDU MFB subfield 344, a three-bit number of spatial streams (NSS) subfield 346, a four-bit EHT-MCS subfield 348, an eight-bit resource unit (RU) allocation subfield 350, a one-bit PS160 subfield 352, a three-bit bandwidth (BW) subfield 354, a three-bit MCS request sequence identifier (MSI)/partial PPDU parameters subfield 356, a one-bit TX beamforming subfield 358, and a one-bit HLA/ELA subfield 360.

In accordance with this approach, a transmitter requests a feedback for MCS and other transmission parameters from a receiver. The receiver monitors the received packets or channel characteristics. The receiver computes the optimal MCS and other parameters, and provides the response to the transmitter as a feedback.

Because the HT control field 318 can only be present in QoS data/null/management frames, the HTC-based approach cannot be widely adopted for LA control. Moreover, in HTC-based approach, the result may not be trustworthy for the transmitter. For example, the receiver computation might be based on maximizing throughput, while the transmitter may want to reduce retransmission. In addition, the hardware at the receiver may not finish the computational task in time, especially when it comes to unequal (UEQ) MCS/unequal modulation (UEQM).

ACK-based LA approach, on the other hand, leverages the ACKs to adjust the transmission parameters dynamically. When a transmitter sends a data packet, it expects an ACK from the receiver to consider the transmission successful. The transmitter keeps track of the success and failure rates of the transmitted packets based on whether ACKs are received or not.

The transmitter can sample specific MCS, NSS, guard interval (GI), bandwidth, and other parameters over a certain probing interval. Based on measurements such as block acknowledgements (BA), received signal strength indicator (RSSI), throughput, and the like, the transmitter can gradually derive a next data rate till a stable data rate is achieved.

For example, a high percentage of packets being acknowledged indicates that the channel is in a good condition. In this case, the transmitter may increase the MCS level to improve the data rate. On the other hand, a low percentage of acknowledged packets indicates poor channel condition. The transmitter may decrease the MCS level to use simpler modulation schemes and more error correction. This decreases the data rate but improves reliability.

There are also several limitations to the ACK-based approach. In particular, ACK-based LA approach does not adapt sufficiently fast to changes and does not use the spectrum resources very efficiently. Moreover, the transmitter does not have much information other than BA and RSSI to predict the situation at the receiver side. The receiver may experience different interferences which the transmitter is unaware of.

Various embodiments disclosed herein provide an improved and/or alternative LA communication method between a first communication device (may be referred to as the “transmitting device”, or simply “transmitter”) and a second communication device (may be referred to as the “receiving device”, or simply “receiver”) that can address at least some of the limitations of the existing approaches. One or both of the first communication device and the second communication device may comprise a multi-link entity or act as a component of a multi-link entity. The first communication device may be an AP 102 or a STA 112, and the second communication device may also be an AP 102 or a STA 112.

For purposes of various embodiments of this disclosure, LA parameters described herein can include but are not limited to MCS, NSS, allocated RU, GI, bandwidth, data rates, power control settings, and the like. In some embodiments, LA parameters or related information may be categorized between measurements and computation results. Measurements assessing channel conditions can comprise parameters such as signal-to-noise ratio (SNR), signal-to-interference-plus-noise ratio (SINR), packet error rates (PER), block error rate (BLER), RSSI, and/or throughput. Computations of LA can involve, for example, selecting an optimal MCS based on metrics such as SNR, SINR, and/or channel quality indicator (CQI). LA information is information relating to one or more LA parameters. It should be understood that LA parameters and LA information may not be limited to the examples explicitly disclosed but can include any signal, transmission, packet, and/or channel parameter(s) and related information that are suitable for facilitating link adaptation to varying channel conditions.

For example, the WI-FI® system can switch between different MCS levels based on factors such as interference, motion and/or fading. Higher MCS levels offer higher data rates but require better signal qualities as they use less error correction. Adjusting NSS in multiple input multiple output (MIMO) systems can enhance throughput based on channel conditions. The system can also switch to different frequency channels (e.g., different RUs) to avoid interference or adapt the channel bandwidth to balance between throughput and interference resistance.

In some embodiments, the LA communication methods introduce an LA negotiation field in the add block acknowledgement (ADDBA) request frame and the ADDBA response frame for negotiation of at least one LA parameter of the communication link. The LA negotiation field can be a new field added to the ADDBA request or response frame; or included in an existing field of the ADDBA request or response frame.

Alternatively or additionally, the LA communication methods can utilize block acknowledgement request (“BAR”, or “BlockAckReq”) frames and block acknowledgement (“BA”, or “BlockAck”) frames for exchanging LA information, by either introducing new fields in the BAR and BA frames, or using existing bits in the BAR and BA frames.

The LA communication method described herein may be used in various wireless communication systems and devices such as WI-FI® AP 102 and STA 112, including WI-FI® 8 AP 102 and STA 112 with multi-link (such as multi-band and/or multi-channel) capability. Accordingly, the LA communication method described herein may be suitable for the standardization of next generation of IEEE 802.11.

Embodiments are described below, by way of example only, with reference to FIGS. 6-16.

According to one aspect of this disclosure, the ADDBA frames can be used for communication of LA information during an initialization of the block acknowledgement (block ACK) mechanism between the transmitter and the receiver. A field for negotiation of at least one LA parameter is included in an ADDBA frame, referred to as an LA negotiation field. In some embodiments described herein, the link adaptation negotiation field can be a new field added to the ADDBA request/response frame for LA negotiation. In some alternative embodiments, an existing field in the ADDBA request/response frame can be used as the link adaptation negotiation field.

In some embodiments, each of the ADDBA request frame and the ADDBA response frame comprises a newly added LA negotiation field for negotiation of at least one LA parameter. Table 2 shows the format of an ADDBA request frame action field; and Table 3 shows the format of an ADDBA response frame action field. As shown in Tables 2 and 3, fields 13 and 15 can be added to the ADDBA request frame and the ADDBA response frame respectively for LA negotiation.

TABLE 2
ADDBA Request Frame Action Field Format

| Order | Information |
|---|---|
| 1 | Category |
| 2 | Block Ack Action |
| 3 | Dialog Token |
| 4 | Block Ack Parameter Set |
| 5 | Block Ack Timeout Value |
| 6 | Block Ack Starting Sequence Control |
| 7 | GCR Group Address element (optional) |
| 8 | Multi-band (optional) |
| 9 | Traffic Classification (TCLAS) (optional) |
| 10 | ADDBA Extension (optional) |
| 11(11ay) | Enhanced Directional Multi-Gigabit |
| | (EDMG) Flow Control Extension |
| | Configuration (optional) |
| 12(11ay) | Segmentation and Reassembly (SAR) |
| | Configuration (optional) |
| 13 | LA Negotiation (optional) |

TABLE 3
ADDBA Response Frame Action Field Format

| Order | Information |
|---|---|
| 1 | Category |
| 2 | Block Ack Action |
| 3 | Dialog Token |
| 4 | Status Code |
| 5 | Block Ack Parameter Set |
| 6 | Block Ack Timeout Value |
| 7 | GCR Group Address element (optional) |
| 8 | Multi-band (optional) |
| 9 | TCLAS (optional) |
| 10 | ADDBA Extension (optional) |
| 11 | Reserved |
| 12(11ay) | EDMG Flow Control Extension |
| | Configuration (optional) |
| 13(11ay) | SAR Configuration (optional) |
| 14 | Originator Preferred MCS |
| | element(optional) |
| 15 | LA Negotiation (optional) |

In this structure, “optional” indicates that the LA negotiation field may or may not be present in an ADDBA frame, depending on whether the corresponding ADDBA frame supports LA negotiation.

In some alternative embodiments, an existing field in an ADDBA request/response frame can be used as or comprising the LA negotiation field. For example, the ADDBA extension field (e.g., field 10) in an ADDBA request/response frame can be used as or comprising the LA negotiation field.

In some embodiments, the LA negotiation field comprises a criterion based on at least one LA measurement and a corresponding level of the at least one LA measurement. For example, the criterion can be based on one or more LA measurements such as throughput, SNR, PER, or the like. By using the LA negotiation field, the criterion and the corresponding level can be negotiated and/or established between the transmitter and the receiver during the initialization of the block ACK session. For example, through the exchange of ADDBA frames, it is negotiated between the transmitter and the receiver which measurement, and its corresponding level should be considered when the receiver is calculating the optimal signal parameters such MCS, NSS, UEQM Pattern, BW, and the like. The LA negotiation field can be of any suitable size and/or structure for exchanging and negotiation of the LA information.

For example, the LA negotiation field may comprise a first subfield for specifying a certain criterion based on one LA measurement (e.g., throughput larger than), and a second subfield for specifying the corresponding level of the respective LA measurement. The LA negotiation field may comprise one or more pairs of the first and second subfields, corresponding to the one or more LA measurements specified in the LA negotiation field. The LA negotiation field may have a fixed size for including criteria and corresponding level(s) for a set of one or more predetermined or predefined specific LA measurements. The set of specific LA measurements may have been previously agreed upon or known. Alternatively, the LA negotiation field may have a variable size for including criteria and corresponding level(s) for one or more LA measurements selected at the transmitter, providing more flexibility for the transmitter to exchange LA information relevant to its determination. Additional information may be used to indicate the number of LA measurements and/or their structure.

In these embodiments, the LA communication method described herein enable efficient exchange of LA information without relying on individual acknowledgements, thereby improving network throughput and adaptation speed compared to existing ACK-based approaches. In many applications, the LA communication method described herein provides more control for the transmitter to obtain relevant LA information thereby establishing more trust for the transmitter to use the LA information for its successful transfer of data to the receiver.

In some implementations, the exchange of the ADDBA request/response frames with the LA negotiation fields can be used as an initialization or prerequisite of an LA communication method described below using BAR/BA frames. Alternatively or additionally, the LA communication method using BAR/BA frames can be used as a standalone method for exchanging and negotiation of LA information.

According to one aspect of this disclosure, the LA communication method described herein exchange and negotiate LA information using one or more BAR frames and BA frames.

In some embodiments, the LA communication method comprises an exchange of an LA information request and an LA information response using a BAR frame and a BA frame respectively. In such embodiments, the BAR frame comprises an LA information request for feedback of at least one LA parameter; and the BA frame comprises an LA information response relating to the requested at least one LA parameter.

In some embodiments, the BAR frame comprises a new first LA information field specifying the LA information request, where the transmitter requests the feedback of the at least one LA parameter using the first LA information field. The first LA information field can be positioned after a BAR control field or a BAR information field in the BAR frame.

FIG. 6 shows a schematic structure of a block ACK request (or “BAR”) frame 400 carrying LA information, in accordance with some embodiments of this disclosure.

The BAR frame 400 comprises a two-byte frame control field 402, a two-byte duration field 404, a six-byte receiver address (RA) field 406, a six-byte transmitter address (TA) field 408, a two-byte BAR control field 410, a BAR information field 414 of a variable size, and a four-byte FCS field 416. As shown in FIG. 6, the block ACK request frame 400 also comprises a new first LA information field 412 for specifying the LA information request.

In the embodiment shown in FIG. 6, the LA information field 412 is positioned between the BAR control field 410 and the BAR information field 414. Alternatively, the LA information field 412 can be positioned after the BAR information field 414. The LA information field 412 can be of a suitable fixed or variable size for specifying the LA information request.

For example, the LA information field 412 may indicate one or more of LA parameters requested by the transmitter for feedback. The LA information field 412 can comprise a suitable size sufficient for specifying different variations of the LA parameter(s), such as variations for MCS, NSS, and/or UEQM patterns. The LA information field 412 may have a fixed size for indicating a predetermined or predefined set of one or more specific LA parameters. The set of specific LA parameters may have been previously agreed upon or known. Alternatively, the LA information field 412 may have a variable size and structure for including one or more LA parameters selected at the transmitter.

In some embodiments, one of the reserved bits in the BAR control field 410 can be used to indicate the existence of the first LA information field 412 for the LA request, i.e., LA information. As shown in FIG. 6, the BAR control field 410 can comprise a one-bit reserved subfield 420, a four-bit BAR type subfield 422, a seven-bit reserved subfield 424, and a four-bit traffic identifier-information (TID-INFO) subfield 426. For example, one reserved bit from the reserved subfield 424, e.g. B5, can be used to indicate the existence of the first LA information field 412 in the BAR frame 400.

In some embodiments, the receiver responds to the LA request in the BAR frame using a BA frame. In these embodiments, the BA frame comprises a second LA information field specifying the LA information response. The second LA information field can be positioned after a BA control field or a BA information field in the BA frame.

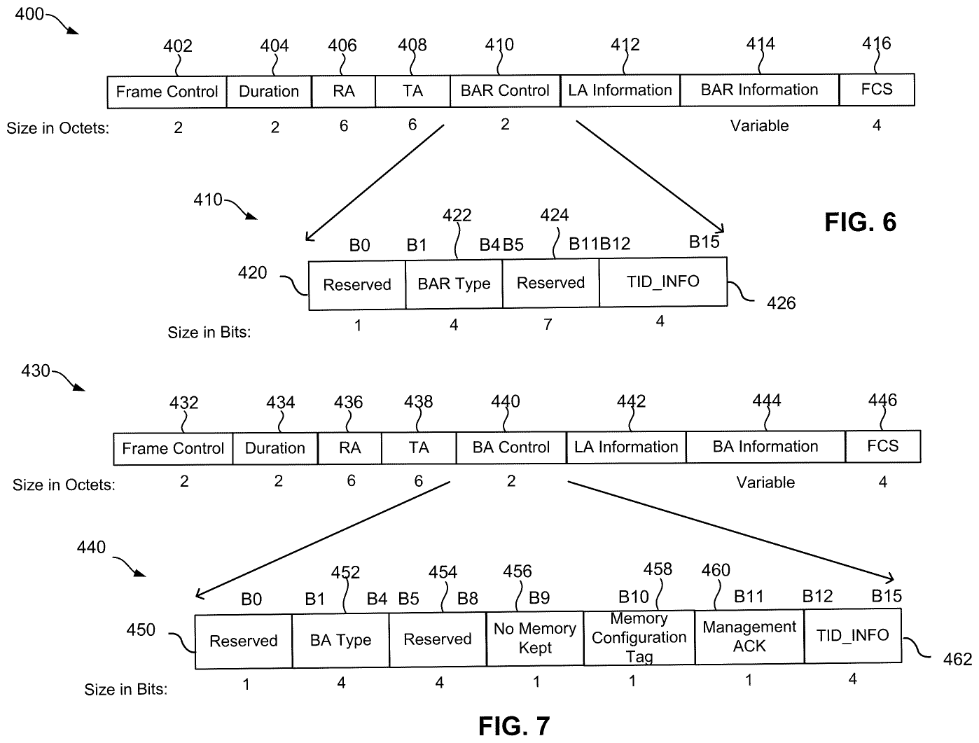

FIG. 7 shows a schematic structure of a BA frame 430 carrying LA information, in accordance with some embodiments of this disclosure.

The BA frame 430 comprises a two-byte frame control field 432, a two-byte duration field 434, a six-byte RA field 436, a six-byte TA field 438, a two-byte BA control field 440, a BA information field 444 of a variable size, and a four-byte FCS field 446. As shown in FIG. 7, the BA frame 430 also comprises a new second LA information field 442 for specifying the LA information response.

In the embodiment shown in FIG. 7, the second LA information field 442 is positioned between the BA control field 440 and the BA information field 444. Alternatively, the second LA information field 442 can be positioned after the BAR information field 444. The second LA information field 442 can be of a suitable fixed or variable size and structure for specifying the LA information response.

In some embodiments, the LA information response can indicate at least one recommendation from the receiver relating to the at least one LA parameter. Alternatively or additionally, the LA information response can indicate at least one measurement required at the transmitter for decision making of the at least one LA parameter. For example, the LA information response can specify at least one recommended signal parameter calculated by the receiver or can include at least one measurement such as an average SNR per stream or the like, which can help the transmitter to make the decision for signal parameter(s).

For example, the LA information field 442 can comprise a suitable size sufficient for specifying the at least one recommendation and/or measurement. The LA information field 442 may have a fixed size for specifying recommendation(s) and/or measurement(s) relating to a predetermined or predefined set of one or more specific LA parameters. The set of specific LA parameters may have been previously agreed upon or known. Alternatively, the LA information field 442 may have a variable size for specifying recommendation(s) and/or measurement(s) relating to one or more LA parameters selected at the transmitter.

In some embodiments, one of the reserved bits in the BA control field 440 can be used to indicate the existence of the second LA information field 442 for the LA response, i.e., LA information. As shown in FIG. 7, the BA control field 440 can comprise a one-bit reserved subfield 450, a four-bit BA type subfield 452, a four-bit reserved subfield 454, a one-bit no memory kept subfield 456, a one-bit memory configuration tag subfield 458, a one-bit management ACK subfield 460, and a four-bit TID-INFO subfield 462. For example, a reserved bit from the reserved subfield 454, e.g. B5, can be used to indicate the existence of the second LA information field 442 in the BA frame 430.

In some embodiments, the receiver can provide its recommendation for increasing the MCS level in a BA frame. In such embodiments, the recommendation can be provided from the receiver without any specific request from the transmitter for LA information.

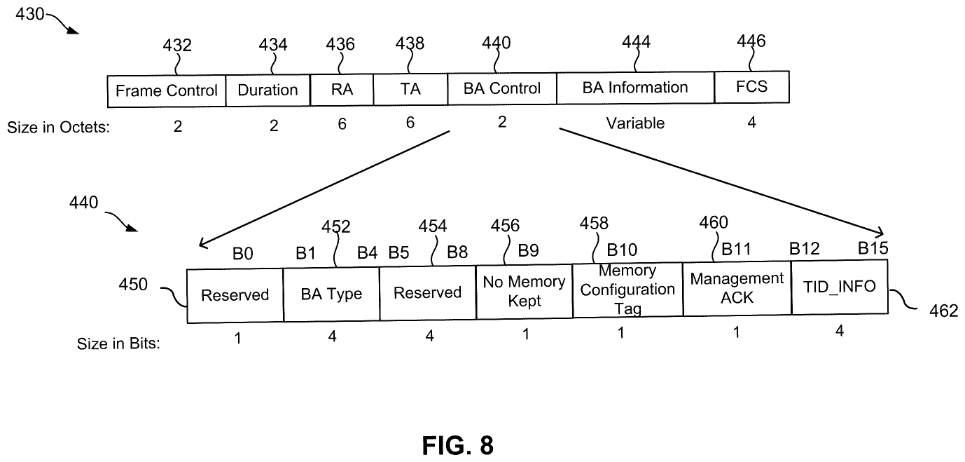

FIG. 8 shows a schematic structure of a BA frame 430, in accordance with these embodiments of this disclosure. In these embodiments, the BA frame 430 comprises a recommendation for increasing the MCS level of the communication link between the transmitter and the receiver.

Compared to the embodiments shown in FIG. 7, the BA frame 430 as shown in FIG. 8 does not include an LA information field 442. Instead, the BA control field 440 comprises a predetermined or predefined number of bits to specify the recommendation for increasing the MCS level. For example, two reserved bits from B5-B8 of the four-bit reserved subfield 454 in the BA control field 440 can be used for specifying the recommendation for increasing the MCS level of the communication link between the transmitter and the receiver.

In some embodiments, the recommendation for increasing the MCS level comprises a two-bit value k indicating the recommendation for increasing the MCS level by m×k levels (where k is an integer from 1 to 4, and m can be any suitable predetermined or predefined integer larger or equal to 1). By way of an example, if the value k is two (2), the recommendation is to increase the MCS level by 2 m levels.

In some embodiments, instead of introducing new fields in the BAR and BA frames, existing reserved bits in the BAR and BA frames can be used for carrying LA information.

In some embodiments, the BAR information field in the BAR frame can be used to specify the LA information request; and the BA information field in the BA frame can be used to specify the LA information response.

FIG. 9 shows a schematic structure of a BAR frame 400 carrying LA information, in accordance with some embodiments of this disclosure.

Compared to FIG. 6, the BAR frame 400 does not include a separate LA information field 412. Instead, the LA information request is comprised in the BAR information field 414 which is of a variable size.

In these embodiments, the transmitter requests the feedback for at least one LA parameter in BAR frame through an LA information request included in the BAR information field 414. The LA information request can be of a suitable fixed or variable size and structure.

For example, the LA information request may indicate one or more LA parameters requested for feedback. The LA information request can comprise a suitable size sufficient for specifying different variations of the LA parameter(s), such as variations for MCS, NSS, and/or UEQM patterns. The LA information request may have a fixed size for indicating a predetermined or predefined set of one or more specific LA parameters. The set of specific LA parameters may have been previously agreed upon or known. Alternatively, the LA information request may have a variable size for including one or more LA parameters selected at the transmitter.

Table 4 shows reserved BAR types indicated in the four-byte BAR type subfield 422. In some embodiments, one of the reserved types in the BAR type subfield 422 can be used to indicate the existence of the LA information request. Each of the reserved types can be indicated by one of the values from zero (0) to fifteen (15) specified in the BAR type subfield 422. For example, a reserved type five (5) in the BAR type subfield 422 can be used to indicate the existence of the LA information request in the BAR frame 400.

TABLE 4
Reserved BAR Types

| BAR Type | BlockAckReq frame variant |
|---|---|
| 0 | Reserved |
| 1 | Extended Compressed |
| 2 | Compressed |
| 3 | Multi-TID |
| 4-5 | Reserved |
| 6 | GCR |
| 7-9 | Reserved |
| 10 | GLK-GCR |
| 11-15 | Reserved |

In some embodiments, the BA information field in the BA frame can be used to specify the LA information response relating to the at least one LA parameter.

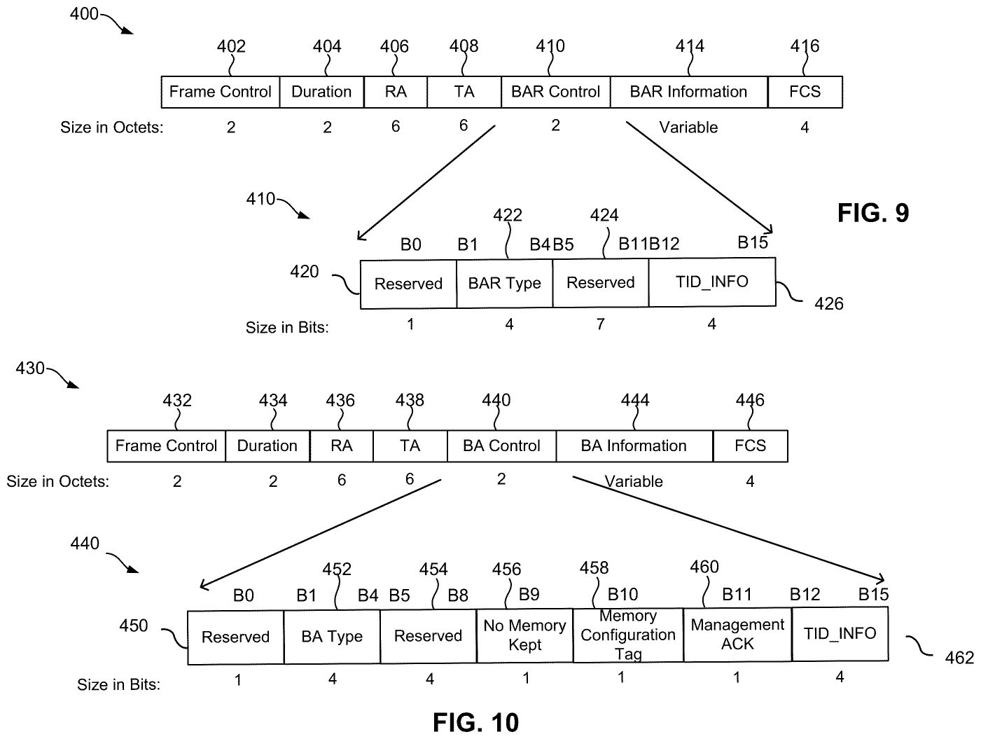

FIG. 10 shows a schematic structure of a BA frame 430 with LA information, in accordance with some embodiments of this disclosure.

Compared to FIG. 7, the BA frame 430 does not include a separate LA information field 442. Instead, the LA information response is comprised in the BA information field 444 which is of a variable size.

In these embodiments, the receiver provides its recommendation(s) for at least one LA parameter in a BA frame through an LA information response included in the BA information field 444. The LA information response can be of a suitable fixed or variable size and structure for specifying the recommendations and/or measurements relating to the requested parameter(s).

In particular, the LA information response can indicate at least one recommendation from the receiver relating to the at least one LA parameter. Alternatively or additionally, the LA information response can indicate at least one measurement required at the transmitter for decision making of the at least one LA parameter. For example, the LA information response can specify at least one recommended signal parameter calculated by the receiver or can include at least one measurement such as an average SNR per stream or the like, which can help the transmitter to make the decision for signal parameter(s).

For example, the LA information response can comprise a suitable size sufficient for specifying the at least one recommendation and/or measurement. The LA information response may have a fixed size for specifying recommendation(s) and/or measurement(s) relating to a predetermined or predefined set of one or more specific LA parameters. The set of specific LA parameters may have been previously agreed upon or known. Alternatively, the LA information response may have a variable size for specifying recommendation(s) and/or measurement(s) relating to one or more LA parameters selected at the transmitter.

Table 5 shows the reserved BA types indicated in the four-bit BA type subfield 452. In some embodiments, one of the reserved types in the BA type subfield 452 can be used to indicate the existence of the LA information response. Each of the reserved types can be indicated by one of the values from zero (0) to fifteen (15) specified in the BA type subfield 452. For example, a reserved type five (5) in the BA type subfield 452 can be used to indicate the existence of the LA information response in the BA frame 430.

| BA Type | BlockAck frame variant |
|---|---|
| 0 | Reserved |
| 1 | Extended Compressed |
| 2 | Compressed |
| 3 | Reserved |
| 4-5 | Reserved |
| 6 | GCR |
| 7 | EDMG Multi-TID |
| 8 | EDMG Compressed |
| 9 | Reserved |
| 10 | GLK-GCR |
| 11 | Multi-STA |
| 12-15 | Reserved |

According to some embodiments of this disclosure, the transmitter can request the feedback for a specific signal parameter in a BAR frame; and the receiver can provide its recommendation and/or related measurements for the requested parameter in a BA frame.

In these embodiments, the BAR frame comprises an LA information request for feedback of a single LA parameter of the communication link. FIG. 11 shows a schematic structure of a BAR frame 400 carrying LA information, in accordance with these embodiments of this disclosure.

As shown in FIG. 11, the BAR frame comprises a BAR control field 410 including two bits for specifying the LA information request for feedback of the single LA parameter. For example, two (2) bits from B5-B11 of the seven-bit reserved subfield 424 in the BAR control field 410 can be used to specify the requested parameter.

In some embodiments, the single LA parameter is one of a MCS, an NSS, a UEQM pattern, or any other parameter of the communication link that can be indicated using the two (2) bits in the BAR control field 410.

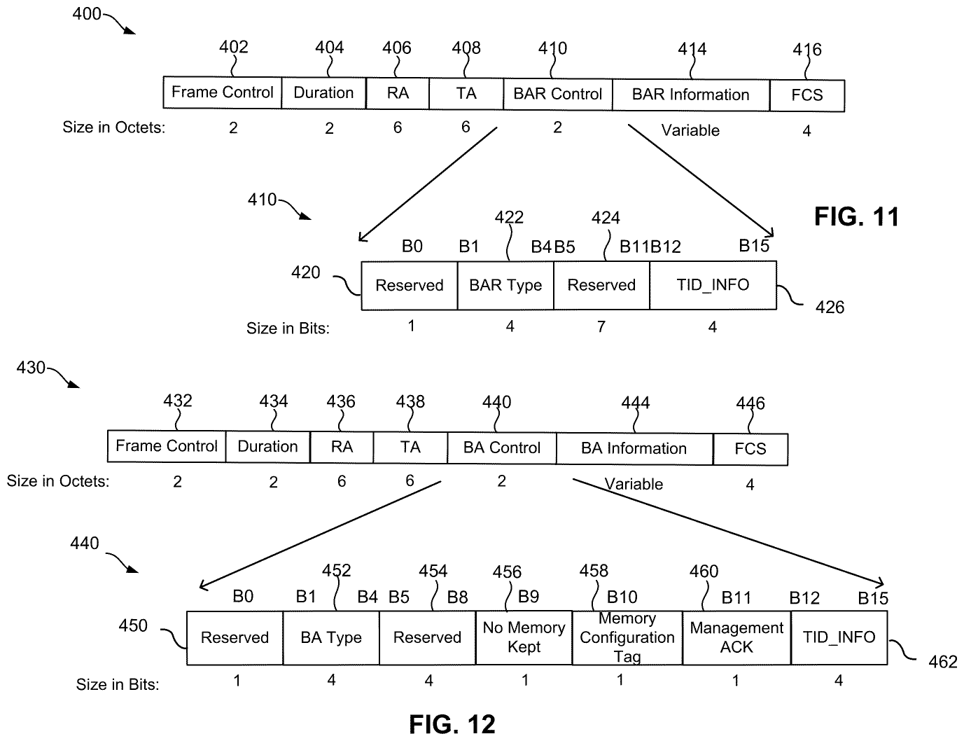

In some embodiments, the receiver provides its recommendation and/or related measurements for the requested parameter in a BA frame. FIG. 12 shows a schematic structure of a BA frame 430 carrying LA information, in accordance with these embodiments of this disclosure.

As shown in FIG. 12, the BA frame 430 comprises a BA control field 440 including four bits for specifying the LA information response of the single LA parameter. For example, four (4) bits from B5-B8 of the four-bit reserved subfield 454 in the BA control field 440 can be used to specify the recommendation and/or related measurements for the requested parameter.

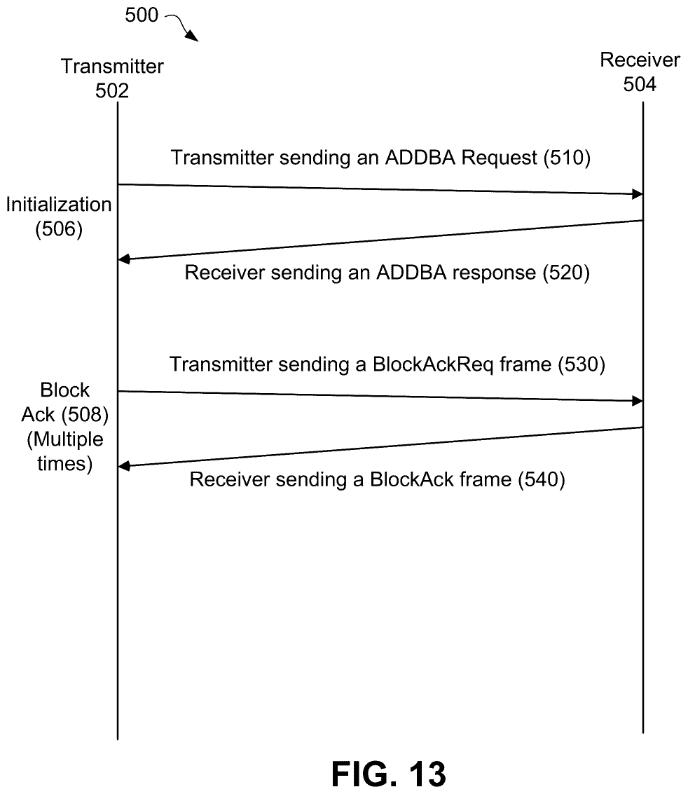

FIG. 13 shows a schematic diagram of the LA communication method 500, according to some embodiments of the disclosure.

Referring to FIG. 13, the LA communication method 500 can exchange and negotiate LA information using various block ACK frames.

In particular, the LA communication method 500 can comprise exchange and negotiation of LA information during an initialization stage (506) of the block ACK mechanism between a transmitter 502 and a receiver 504. Alternatively or additionally, the LA communication method 500 can comprise exchange and negotiation of LA information during the block ACK stage (508). LA information may be exchanged multiple times between the transmitter 502 and the receiver 504 using the BAR/BA frames.

In some embodiments, the LA communication method 500 starts by the transmitter 502 sending (510) an ADDBA request frame to the receiver 504. Upon receiving the ADDBA request frame, the receiver 504 sends (520) an ADDBA response frame to the transmitter 502 through the communication link. Each of the ADDBA request frame and the ADDBA response frame comprises an LA negotiation field for negotiation of at least one LA parameter of the communication link.

Alternatively or additionally, the LA communication method 500 can comprise the transmitter 502 sending (530) one or more BAR frames to the receiver 504, where each BAR frame comprises an LA information request for feedback of at least one LA parameter of the communication link. Upon receiving each BAR frame containing the LA information request, the receiver 504 sends (540) a corresponding BA frame to the transmitter through the communication link, where each BA frame comprises an LA information response relating to the requested at least one LA parameter of the communication link.

In some implementations, the exchange of the ADDBA request/response frames carrying LA information can be used as an initialization or prerequisite of the exchange of BAR/BA frames carrying LA information. Alternatively or additionally, the LA communication method using BAR/BA frames can be used as a standalone method for exchanging LA information.

For example, an initial negotiation of LA information can be performed during the initialization (506) of the block ACK mechanism through an exchange of ADDBA frames supporting LA negotiation. Further exchange of LA information can be performed using one or more BAR and BA frame pairs. Each pair of BAR and BA frames may exchange information relating to a same set (or a subset) of LA parameter(s) as those negotiated by the exchange of ADDBA frames; or a different set of LA parameter(s) compared to those negotiated by the exchange of ADDBA frames. Further, information relating to a same set of LA parameter(s) can be exchanged or negotiated multiple times through multiple pairs of BAR and BA frames. Alternatively, information relating to a different set of LA parameter(s) can be exchanged each time when using a pair of BAR and BA frames.

Accordingly, the LA communication method described herein provides several opportunities to exchange and negotiate LA information between the transmitter and the receiver to enable the transmitter to obtain LA information that is negotiated and/or agreed upon by both parties. Compared to the HTC-based approaches, the embodiments disclosed herein provide a more flexible, robust, and reliable LA communication method to adapt to the varying conditions of the channel. The transmitter can also obtain LA information beyond the block ACK and the RSSI to evaluate the channel conditions and can in turn provide more effective LA measures adjusting to the channel conditions.

In some embodiments, the LA information response relating to the LA parameter of the communication link may be sent by the receiver 504 without the transmitter 502 requesting for feedback of the LA parameter.

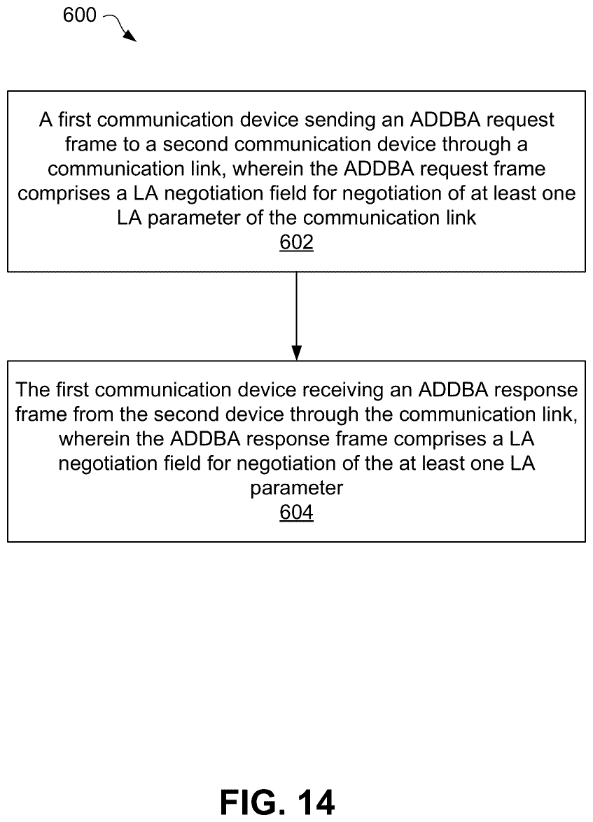

FIG. 14 is a flow chart of a first communication method (600) performed at the transmitter 502, in accordance with some embodiments of the disclosure.

The first communication method (600) starts by a first communication device (e.g., transmitter 502) sending (602) an ADDBA request frame to a second communication device (e.g., receiver 504) through a communication link, wherein the ADDBA request frame comprises an LA negotiation field for negotiation of at least one LA parameter of the communication link. The first communication device (604) then receives an ADDBA response frame from the second device through the communication link, wherein the ADDBA response frame comprises an LA negotiation field for negotiation of the at least one LA parameter.

Each LA negotiation field may comprise a criterion based on the at least one LA measurement and a corresponding level of the at least one LA measurement. The at least one LA measurement may comprise one or more of a throughput, a signal-to-noise ratio (SNR), or a packet error rate (PER) of the communication link. The LA negotiation field can be a new field added to the corresponding ADDBA request or response frame; or can be included in an existing field of the corresponding ADDBA request or response frame.

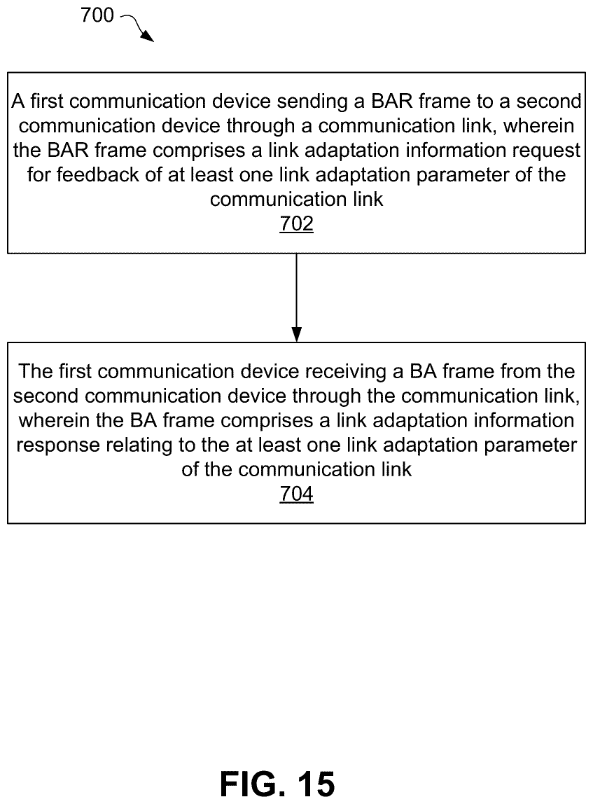

FIG. 15 is a flow chart of a second communication method (700) performed at the transmitter 502, in accordance with some embodiments of the disclosure.

The second communication method (700) starts by a first communication device (e.g., transmitter 502) sending (702) a BAR frame to a second communication device (e.g., receiver 504) through a communication link, wherein the BAR frame comprises an LA information request for feedback of at least one LA parameter of the communication link. The first communication device then receives (704) a BA frame from the second communication device through the communication link, wherein the BA frame comprises an LA information response relating to the at least one LA parameter of the communication link.

Referring to FIGS. 6 and 7, the BAR frame 400 can comprise a first LA information field 412 specifying the LA information request; and the BA frame 430 can comprise a second LA information field 442 specifying the LA information response. The first LA information field 412 can be positioned after a BAR control field 410 or a BAR information field 414 in the BAR frame 400. Similarly, the second LA information field 442 can be positioned after a BA control field 440 or a BA information field 444 in the BA frame 430.

In some embodiments, the BAR control field 410 may comprise one bit indicating an existence of the first LA information field 412 in the BAR frame 400; and the BA control field 440 may comprise one bit indicating an existence of the second LA information field in the BA frame 430.

In some embodiments, the LA information response may comprise a recommendation or measurement relating to the at least one LA parameter.

Referring now to FIGS. 9 and 10, the BAR frame 400 can alternatively comprise a BAR information field 414 specifying the LA information request. Similarly, the BA frame 430 can comprise a BA information field 444 specifying the LA information response.

In these embodiments, the BAR frame 400 can comprise a BAR type subfield 422 including one value indicating an existence of the LA information request in the BAR frame 400; and the BA frame 430 can comprise a BA type subfield 452 including one value indicating an existence of the LA information response in the BA frame 430.

Referring further to FIGS. 11 and 12, the LA information request for feedback of the at least one LA parameter may comprise a request for feedback of a single LA parameter of the communication link.

In such embodiments, the BAR frame 400 can comprise a BAR control field 410 including two bits for specifying the LA information request for feedback of the single LA parameter. The BA frame 430 can comprise a BA control field 440 including four bits for specifying the LA information response of the single LA parameter. The single LA parameter may be one of a MCS, an NSS, a UEQM pattern, or any other type of LA parameter of the communication link that can be indicated using two bits.

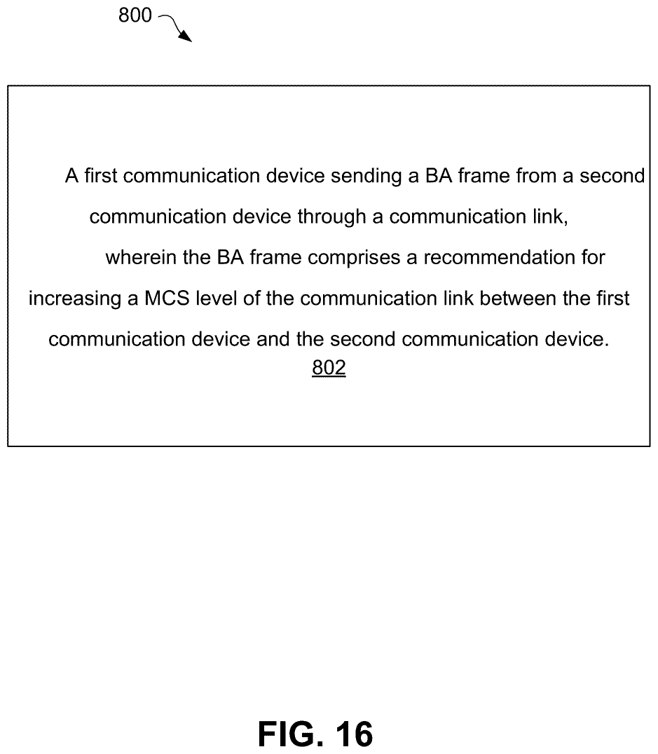

FIG. 16 is a flow chart of a third communication method (800) performed at the transmitter 502, in accordance with some embodiments of the disclosure.

The third communication method (800) comprises a first communication device (e.g., transmitter 502) receiving a BA frame 430 from a second communication device (e.g., receiver 504) through a communication link, wherein the BA frame 430 comprises a recommendation for increasing a MCS level of the communication link between the first communication device and the second communication device.

Referring to FIG. 8, the BA frame 430 can comprise a BA control field 440, and the BA control field 440 may comprise two bits for specifying the recommendation for increasing the MCS level of the communication link between the first communication device and the second communication device. The recommendation for increasing the MCS level may comprise a two-bit value k indicating the recommendation for increasing the MCS level by m×k levels, where m is an integer larger or equal to 1.

Herein, the disclosed LA communication method provides various ways of exchanging and negotiating LA information. In some embodiments, the negotiation of LA information for at least one LA parameter can be provided between the transmitter and the receiver in ADDBA frames. By introducing an LA negotiation field in the ADDBA request and response frames (either as a new field or included in an existing field), LA information can be negotiated/established during the initialization of a block ACK session.

Alternative or additionally, LA information can be exchanged through one or more pairs of BAR/BA frames. In some embodiments, various methods to use BAR for requesting LA parameters are described, by either introducing a new field in the BAR frame, or using reserved bits in the BAR frame. Similarly, various methods to use BA for responding to the LA parameters request are also described, by either introducing a new field in the BA frame, or using reserved bits in the BA frame.

The described LA communication method therefore allows efficient and effective exchange of LA information without relying on individual acknowledgements, thereby improving network throughput and adaptation speed compared to existing ACK-based approaches.

The transmitter can also negotiate and/or exchange LA information beyond the block ACK and the RSSI to evaluate the channel conditions and can in turn provide more effective LA measures adjusting to the channel conditions.

The LA communication method in various embodiments described herein therefore addresses the problem of trust between the transmitter and the receiver, by providing a negotiation strategy and/or exchange method of one or more LA parameters between the transmitter and the receiver.

As can be appreciated from the description, the LA communication method according to various embodiments utilizes block ACK frames to offer a fast and efficient LA approach in comparison to the existing ACK-based approaches which suffer from a slow convergence and a more reliable LA approach in comparison to the existing HTC-based approaches.

### D. Acronyms, Abbreviations, and Definition of Some Terms

| Full Name | Acronym/Abbreviation/Initialism |
|---|---|
| Access Category | AC |
| Access Point | AP |
| Distributed Coordination | DCF |
| Function | |
| Downlink | DL |
| Enhanced Distributed | EDCA |
| Channel Access | |
| Transmitter | TX |
| Receiver | RX |
| Station | STA |
| Up Link | UL |
| Down Link | DL |
| Multi User Multiple | MU-MIMO |
| Input Multiple Output | |
| Single User Multiple | SU-MIMO |
| Input Multiple Output | |
| Signal to Noise Ratio | SNR |
| Beamforming | BF |
| Modulation and Coding System | MCS |
| High Throughput | HT |
| High Efficiency | HE |
| Extremely High Throughput | EHT |
| Ultra-High Reliability | UHR |
| Medium Access Control Layer | MAC |
| Singular Value Decomposition | SVD |
| Frame Check Sum | FCS |
| Quality of Service | QoS |
| Spatial Stream | SS |
| Unequal Modulation | UEQM |
| Identification | ID |
| International Electrical | IEEE |
| and Electronic Engineering | |
| Orthogonal Frequency | OFDM |
| Division Multiplexing | |
| Link Adaptation | LA |

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain event occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments are described. In various embodiments, the methods disclosed herein may be implemented as hardware, software, firmware, or a combination thereof, and may be implemented in any suitable form. Depending on the functionalities of various features of the methods disclosed herein, some features may be implemented on the network side (such as in one or more APs), some other features may be implemented on the STA side, and/or yet some other features may be implemented on both the AP and the STA sides. Depending on the functionalities of various features of the methods disclosed herein, some features may be implemented on the transmitting side (such as in one or more APs and/or one or more STAs for transmission), some other features may be implemented on the receiving side (such as in one or more APs and/or one or more STAs for receiving), and/or yet some other features may be implemented on both the transmitting and the receiving sides.

For example, in some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A communication method comprising:
a first communication device sending an add block acknowledgement (ADDBA) request frame to a second communication device through a communication link; and
the first communication device receiving an ADDBA response frame from the second communication device through the communication link, wherein each of the ADDBA request frame and the ADDBA response frame comprises a link adaptation negotiation field for negotiation of at least one link adaptation parameter of the communication link.

2. The communication method according to claim 1, wherein the link adaptation negotiation field comprises a criterion based on the at least one link adaptation measurement and a corresponding level of the at least one link adaptation measurement.

3. The communication method according to claim 2, wherein the at least one link adaptation measurement comprises one or more of a throughput, a signal-to-noise ratio (SNR), or a packet error rate (PER) of the communication link.

4. The communication method according to claim 1, wherein the link adaptation negotiation field is included in an existing field of the corresponding ADDBA request or response frame.

5. A communication method comprising:
a first communication device sending a block acknowledgement request (BAR) frame to a second communication device through a communication link, wherein the BAR frame comprises a link adaptation information request for feedback of at least one link adaptation parameter of the communication link; and
the first communication device receiving a block acknowledgement (BA) frame from the second communication device through the communication link, wherein the BA frame comprises a link adaptation information response relating to the at least one link adaptation parameter of the communication link.

6. The communication method according to claim 5, wherein
the BAR frame comprises a first link adaptation information field specifying the link adaptation information request, the first link adaptation information field being positioned after a BAR control field or a BAR information field in the BAR frame; and
the BA frame comprises a second link adaptation information field specifying the link adaptation information response, the second link adaptation information field being positioned after a BA control field or a BA information field in the BA frame.

7. The communication method according to claim 6, wherein the BAR control field comprises one bit indicating an existence of the first link adaptation information field in the BAR frame; and the BA control field comprises one bit indicating an existence of the second link adaptation information field in the BA frame.

8. The communication method according to claim 5, wherein the link adaptation information response comprises a recommendation or measurement relating to the at least one link adaptation parameter.

9. The communication method according to claim 5, wherein the BAR frame comprises a BAR type subfield including one value indicating an existence of the link adaptation information request in the BAR frame and the BA frame comprises a BA type subfield including one value indicating an existence of the link adaptation information response in the BA frame.

10. The communication method according to claim 5, wherein
the BAR frame comprises a BAR information field specifying the link adaptation information request; and
the BA frame comprises a BA information field specifying the link adaptation information response.

11. The communication method according to claim 5, wherein the link adaptation information request for feedback of the at least one link adaptation parameter comprises a request for feedback of a single link adaptation parameter of the communication link.

12. The communication method according to claim 11, wherein the BAR frame comprises a BAR control field including two bits for specifying the link adaptation information request for feedback of the single link adaptation parameter.

13. The communication method according to claim 11, wherein the BA frame comprises a BA control field including four bits for specifying the link adaptation information response of the single link adaptation parameter.

14. The communication method according to claim 11, wherein the single link adaptation parameter is one of a modulation and coding scheme (MCS), a number of spatial streams (NSS) and an unequal modulation (UEQM) pattern of the communication link.

15. A communication method comprising:
a first communication device sending a block acknowledgement (BA) frame to a second communication device through a communication link, wherein the BA frame comprises a recommendation for increasing a modulation and coding scheme (MCS) level of the communication link between the first communication device and the second communication device.

16. The communication method according to claim 15, wherein the BA frame comprises a BA control field, and the BA control field comprises two bits for specifying the recommendation for increasing the MCS level of the communication link between the first communication device and the second communication device.

17. The communication method according to claim 15, wherein the recommendation for increasing the MCS level comprises a two-bit value k indicating the recommendation for increasing the MCS level by m×k levels, where m is an integer larger or equal to 1.

18. A communication apparatus comprising: one or more processors functionally connected to one or more non-transitory machine-readable memories storing thereon machine-executable instructions, and the one or more processors are configured to execute the machine-executable instructions and cause the communication apparatus to perform the communication method of claim 1.

19. A communication apparatus comprising: one or more processors functionally connected to one or more non-transitory machine-readable memories storing thereon machine-executable instructions, and the one or more processors are configured to execute the machine-executable instructions and cause the communication apparatus to perform the communication method of claim 5.

20. A communication apparatus comprising: one or more processors functionally connected to one or more non-transitory machine-readable memories storing thereon machine-executable instructions, and the one or more processors are configured to execute the machine-executable instructions and cause the communication apparatus to perform the communication method of claim 15.

21. One or more non-transitory computer-readable storage devices comprising computer-executable instructions, wherein the computer-executable instructions, when executed, cause one or more circuits to perform the communication method of claim 1.
